(19) United States
(12) Patent Application Publication
(10) Pub. No.: US 2021/0008894 A1
(43) Pub. Date: Jan. 14, 2021

(54) THERMAL PRINT PULSE PATTERN

(71) Applicant: Hewlett-Packard Development Company, L.P., Spring, TX (US)

(72) Inventors: Jay S Gondek, Vancouver, WA (US); Jason M Quintana, Vancouver, WA (US)

(21) Appl. No.: 16/981,416

(22) PCT Filed: Apr. 30, 2018
(86) PCT No.: PCT/US2018/030258

§ 371 Date: Sep. 16, 2020

(51) Int. Cl. B41J 2/355; H04N 1/60

(52) U.S. Cl. CPC B41J 2/3558; H04N 1/6094; H04N 1/6091

(57) ABSTRACT

In some examples, a system may include a thermal print head including a plurality of print head elements to heat a print medium. The system may include a controller to determine a tri-color tuple of a pixel of an image to be printed; determine an input temperature at a specific print head element, of the plurality of print head element s, printing the pixel on thermal print medium; and determine a voltage pulse pattern for printing the tri-color tuple at the input temperature based on a previously printed pixel.

### BACKGROUND

Thermal printing may include a digital printing process that utilizes thermal printers to produce a printed image by selectively heating a print medium such as thermal paper. Thermal printers may include an array of print head elements that may activate color forming chemistry of the thermal paper by heating a corresponding area of the thermal paper. The duration and intensity of a heat pulse delivered from the print head element to the thermal paper may cause a desired color to appear on the corresponding area of the print medium.

### BRIEF DESCRIPTION OF THE DRAWINGS

FIG. 1 illustrates an example of a system for thermal print pulse pattern determination consistent with the disclosure.

FIG. 2 illustrates a diagram of an example of a processing resource and a non-transitory computer readable medium for thermal print pulse pattern determination consistent with the disclosure.

FIG. 3 illustrates a flow diagram of an example of a method for thermal print pulse pattern determination consistent with the disclosure.

### DETAILED DESCRIPTION

A thermal printer may include a plurality of heating elements, or print head elements, arrayed across a thermal print head. Each of the print head elements may be heated up by providing the element with energy. For example, the thermal printer may control the temperature that the print head element is heated to and the duration of that the print head element is heated to a temperature by supplying energy to the heating element. The energy may be supplied as a pulse of voltage. The voltage may be supplied to the print head element at a substantially constant amount for a particular duration. The print head element may convert the voltage pulse to heat energy. The duration of the voltage pulse or the amount of voltage pulses provided to the print head element over a period of time may result in the print head element achieving a particular temperature (e.g., pulse intensity) for a particular duration (e.g., pulse length).

The thermal printer may produce a printed image on thermal print media utilizing the heat energy output by the print head elements. In some examples, the thermal printer may produce the entirety of a multi-colored image on the print medium in a single pass of the thermal print head over the print medium. For example, a thermal printer may utilize a thermal print medium that includes a plurality of layers that include particular color-forming chemistries that may be differentially activated by different types of heat treatments. The thermal print medium may include three color forming layers with a base layer, heat throughput-modulating interlayers layers, and/or a coating layer. The three color forming layers may include a first layer with a cyan colored color-forming chemistry, a second layer with a magenta colored color-forming chemistry, and a third layer with a yellow colored color-forming chemistry. A portion of the above-described layers may initially appear colorless. For example, a portion of the layers above the base layer may appear substantially transparent while the base layer may appear white and reflective.

As the print medium is exposed to various heating patterns, the various color forming layers may produce a corresponding color. Since the color forming layers may be located in a stack over each other, different amounts of the three colors, cyan, magenta, yellow (CMY), from their respective color forming layer may visually combine to form any of a number of colors in a color space. For example, the cyan color-forming layer may be heated to a temperature that activates its color-forming chemistry by heating the surface of the print medium to a relatively low temperature (e.g., 100° C.) for a relatively long amount of time. In another example, the magenta color-forming layer may be heated to a temperature that activates its color-forming chemistry by heating the surface of the print medium to an intermediate temperature (e.g., 150° C.) for an intermediate length of time. In yet another example, the yellow color-forming layer may be heated to a temperature that activates its color-forming chemistry by heating the surface of the print medium to a relatively high temperature (e.g., 200° C.) for a relatively short amount of time.

As such, variations to the intensity and duration of heating at the print head element may result in variations in the colors produced on the thermal print medium. As described above, the voltage pulses provided to the print head elements may be utilized to generate the various intensities and durations of heating at the print head element. Particular voltage pulse patterns may be defined by the duration and frequency that a voltage pulse is supplied to the print head element. Particular voltage pulse patterns may produce particular heating intensities and durations at the heating element, which may cause particular colors to be formed on the thermal print medium.

Thermal printing processes may result in a thermal buildup. For example, when printing with a thermal print head, residual thermal energy may begin to build up at local regions of a thermal print head. For example, when some thermal print head elements may retain a portion of the thermal energy left over from a previous pixel it has printed. Such a buildup of thermal energy at the print head element or at adjacent print head elements may alter the effect or end result of a particular voltage pulse pattern on a thermal print head element where the thermal buildup energy is residing, For example, a voltage pulse to a print head element that creates a first color when the print head element is at a first starting temperature, may result in a second color when the print head element is at a second starting temperature.

The same is true of the thermal print medium utilized in the thermal printing process. That is, the thermal energy applied to the surface of a portion of the thermal print medium may not stay contained in a portion of the surface. Instead, the thermal energy may bleed into adjacent portions of the surface of the thermal print medium. A voltage pulse to a print head element that creates a first color at a portion of the thermal print medium when the print head medium is at a first starting temperature, may result in a second color when the print head medium is at a second starting temperature.

Therefore, the thermal conditions at the thermal print head, the thermal print head elements, and the thermal print medium may vary over the course of a print job or from print job to print job. A variation in the appearance of the colors produced on the thermal print medium over the course of the print job or from print job to print job may result. Such variation in colors, especially in photo printing, may produce an inaccurate, inconsistent, and visually unappealing print.

Some approaches to avoiding such color variation may include color correction methods that utilize independent linear thermal color models for each of cyan, magenta, and yellow colors. For example, a color correction method may utilize an independent linear thermal model for cyan that predicts the correction factor applicable to a voltage pulse pattern to attempt to produce a particular cyan color output at a temperature approximated by the average thermal print head temperature. Then, the color correction method may utilize an independent linear thermal model for magenta that predicts the correction factor applicable to a voltage pulse pattern to attempt to produce a particular magenta color output at a temperature approximated by the average thermal print head temperature. Then, the color correction method may utilize an independent linear thermal model for yellow that predicts the correction factor applicable to a voltage pulse pattern to attempt to produce a particular yellow color output at a temperature approximated by the average thermal print head temperature.

Such independent linear models for each of the three color-forming cyan, magenta, and yellow layers of the thermal print medium may be utilized despite the end result on the thermal print medium being a combination of the cyan, magenta, and yellow colors layered over one another and combining to produce a combined color. Attempts to standardize the independent cyan, magenta, and yellow linear color models may involve standardizing the three independent linear color models to one color, such as fifty percent neutral gray. Regardless of the standardization, such independent linear models produced color combinations that print with a visually pronounced color shift from the intended color.

In contrast, examples of the present disclosure may include systems, methods, and machine-readable mediums for thermal print pulse pattern data structures that do not utilize independent thermal linear models. Instead, examples of the present disclosure may provide for a dynamic and/or non-linear relationship between input data for a pixel and a printed color. For instance, in one implementation it may be possible to utilize a data-driven approach employing a data structure including a voltage pulse pattern that produces a targeted and/or correct color for each potential red, green, blue (RGB) tuple value from a digital representation of a pixel to be printed. The data structure may be able to compensate for print head element temperature and/or print medium temperature. For instance, the data structure may include the voltage pulse pattern for potential RGB tuples for a color space printable by a thermal printer using potential temperature at a thermal print head element and/or a potential temperature at an area on a thermal print medium at which a pixel is to be printed. Examples of the present disclosure may determine an RGB tuple of a pixel of an image to be printed, determine an input temperature (e.g., at an area where the pixel is to be printed on the print medium), and determine, by referencing the data structure (and based on the input temperature), a voltage pulse pattern for printing the RGB tuple at the input temperature. The data structure may include, for instance, a table including a voltage pulse pattern for each RGB tuple printable by the thermal print head at each of a plurality of input temperatures. In another example, rather than using an input temperature determined at an area of print medium, an input temperature may be based on a print head element temperature to determine an RGB tuple of a pixel of an image to be printed.

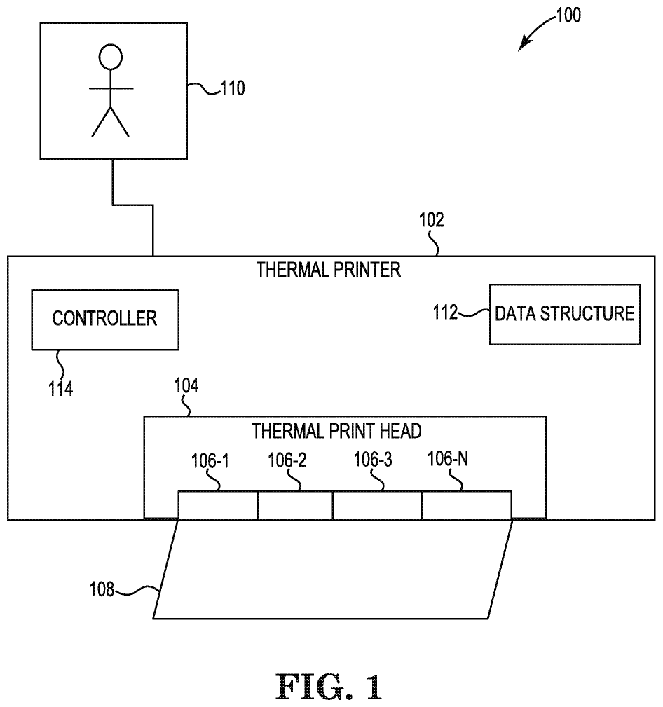

FIG. 1 illustrates an example of a system 100 for thermal print pulse pattern determination consistent with the disclosure. The system 100 may include a thermal printer 102. The thermal printer 102 may be a peripheral device in communication with a separate computing device. The thermal printer 102 may include a combination of logic and machine-readable instructions stored on a machine-readable media to cause a processing resource to perform actions and/or functions associated with thermal print pattern determination.

For example, the thermal printer 102 may include a controller 114, which may include a combination of logic and machine-readable instructions stored on a machine-readable media to cause a processing resource to perform actions and/or functions associated with thermal print pattern determination. As used herein, “logic” may be an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in a memory and executable by a processor. It is presumed that logic similarly executes instructions for purposes of the implementations of the present disclosure.

The thermal printer 102 may include a thermal print head 104. The thermal print head 104 may include a plurality of thermal print head elements 106-1 . . . 106-N. Each of thermal print head elements 106-1 . . . 106-N may include a heating element that receives patterns of voltage pulses and converts the voltage pulses to heat energy. The thermal print head elements 106-1 . . . 106-N may receive independent and/or distinct voltage pulse patterns and may be heated to different temperatures for different durations. The thermal print head elements 106-1 . . . 106-N may contact thermal print media 108 (though in another implementation, thermal print head elements 106-1, . . . , 106-N may be in proximity to, but may not be in physical contact with, thermal print medium 108). The thermal print head elements 106-1 . . . 106-N may transfer the heat energy produced to the thermal print medium 108 to produce color on the thermal print medium 108.

As noted above, the thermal print medium 108 may include three color forming layers with a base layer, heat throughput-modulating interlayers layers, and/or a coating layer. The three color forming layers may include a first layer with a cyan colored color-forming chemistry, a second layer with a magenta colored color-forming chemistry, and a third layer with a yellow colored color-forming chemistry. A portion of the above-described layers may initially appear colorless. For example, a portion of the layers above the base layer may appear substantially transparent while the base layer may appear white and reflective.

In some examples, the thermal print medium 108 may include four color forming layers. For example, the thermal print medium 108 may include a first layer with a cyan colored color-forming chemistry, a second layer with a magenta colored color-forming chemistry, a third layer with a yellow colored color-forming chemistry, and a fourth layer with a key (e.g., black) colored color-forming chemistry. Other combinations and/or numbers of layers are also contemplated by the present disclosure.

The thermal printer 102 may produce a printed thermal print medium 108 based on a received print job. For example, a thermal printer 102 may receive an image 110 to be printed. The image 110 may be received from a separate computing device. The image 110 may be in the form of a digital file including instructions describing the appearance of the image 110. The image 110 may, for example, be made of a plurality of pixels. Each of the pixels of the image 110 may include a particular color, The color at each pixel of the image 110 may be defined utilizing tri-color tuple values. For example, the tri-color tuple may be a tuple of RGB values. In other examples, the tri-color tuple may be a tuple of CMY values. The image 110 may include a map of tri-color tuples for each pixel of the image 110 to be printed.

The controller 114 of the thermal printer 102 may determine the tri-color tuple of each pixel of the image 110 to be printed on the thermal print medium 108. For example, the controller 114 of the thermal printer 102 may analyze, extract, and/or receive the tri-color tuple associated with each of the pixels of the image 110 to be printed on the thermal print medium 108.

As noted above, an input temperature may be used, at least in part, to determine a voltage pulse pattern. The input temperature may be based on a temperature of a thermal print head element and/or a print medium temperature (e.g., a temperature at an area of the thermal print medium where a pixel of an image is to be printed).

In some examples, the controller 114 may determine an input temperature at a particular thermal print head element, of the plurality of thermal print head elements 106-1 . . . 106-N, utilized to print the pixel. The input temperature of the particular print head element may be determined from a temperature sensor that measures the temperature of the particular print head element. For example, the thermal printer 102 may include a sensor array that may determine the input temperature of each individual print head element of the plurality of thermal print head elements 106-1 . . . 106-N. Additionally, the input temperature may be determined based on thermal modeling of the particular thermal print head that utilizes information regarding previous print operations performed by the particular print head. For example, the input temperature of the particular thermal print head may include a starting temperature of the particular thermal print head element of the plurality of thermal print head elements 106-1 . . . 106-N that will be printing (e.g., transferring the heat to activate the color-forming chemistry) the particular pixel of the image 110 on the thermal print medium 108. That is, in these examples, the input temperature may include the starting surface temperature of the particular thermal print head element immediately prior to printing the pixel to be printed. The input temperature may include the starting surface temperature of the particular thermal print head element prior to beginning the thermal printing process of the print job of the image 110. That is, the input temperature may include the starting surface temperature of the particular thermal print head element prior to printing the first pixel of the image 110 onto the thermal print medium 108. In other examples, the input temperature may include the surface temperature of the particular thermal print head element subsequent to beginning the thermal printing process of the print job of the image 110. For example, the input temperature may include the starting surface temperature of the particular thermal print head element immediately subsequent to printing a portion of the pixels of the image 110 but immediately prior to printing a subsequent second portion of the pixels of the image 110.

In some examples, the controller 114 may determine the input temperature of the area of the thermal print medium 108 where the pixel of the image 110 is to be printed. The input temperature of the area of the thermal print medium 108 where the pixel of the image is to be printed may be determined based on a temperature sensor that measures the temperature of the thermal print medium 108. Additionally, the input temperature of the area of the thermal print medium 108 where the pixel of the image is to be printed may be determined based on thermal modeling of the area of the thermal print medium 108 where the pixel of the image is to be printed that utilizes information regarding previous print operations performed at adjacent areas of on the thermal print medium 108. In these examples, the input temperature of the area of the thermal print medium 108 where the pixel of the image is to be printed may include the starting temperature of the thermal print medium 108 at the area of the thermal print medium 108 where the pixel of the image 110 is to be printed. That is, the input temperature at the area of the thermal print medium 108 where the pixel of the image is to be printed may include the temperature of the area of the thermal print medium 108 where the particular thermal print head element will apply heat during the thermal printing process to produce the color of the pixel. The input temperature of the area of the thermal print medium 108 where the pixel of the image is to be printed may include the starting surface temperature of the thermal print medium 108, at the area where the pixel is to be printed, immediately prior to printing the pixel to be printed. As with the input temperature of the surface of the particular print head, the input temperature of the surface of the thermal print medium 108 may or may not be a starting surface temperature of the thermal print medium 108 prior to printing the first pixel of the image 110 onto the thermal print medium 108. In some examples, the input temperature may include the starting temperature of the surface of the thermal print medium 108 where a pixel is to be printed at a time immediately subsequent to printing a first portion of the pixels of the image 110, but immediately prior to printing a subsequent second portion of the pixels of the image 110.

In some examples, a combined input temperature may be determined, The combined input temperature may include a combination of the surface temperature of the area of the thermal print medium 108 where a pixel is to be printed and the surface temperature of the particular thermal print head element that will be providing the thermal energy to print the pixel at the area.

The individual temperature of each of the plurality of thermal print head elements 106-1 . . . 106-N and/or the temperature of the area of the thermal print medium 108 where the pixel is to be printed may be updated after each one of the pixels of the image 110 is printed. For example, after a first pixel of the image 110 is printed, the temperature sensors of the thermal printer 102 may be utilized to determine the individual temperature of each of the plurality of thermal print head elements 106-1 . . . 106-N and/or the temperature of the area of the thermal print medium 108 where the next pixel of the image 110 is to be printed prior to printing the next pixel. In another example, the individual temperature of each of the plurality of thermal print head elements 106-1 . . . 106-N and/or the temperature of the area of the thermal print medium 108 where the next pixel of the image 110 is to be printed prior to printing the next pixel may be determined by calculating the new temperature based on the previous temperature reading and the amount of energy (e.g., voltage pulse pattern) that was utilized in printing the previous pixel of the image 110.

The controller 114 may determine a voltage pulse pattern for producing a copy of the tri-color tuple of the pixel of the image 110 to be printed on the thermal print medium 108 at the determined input temperature of the thermal print head element that will be printing the pixel and/or the input temperature of the area of the print medium 108 where the pixel will be printed.

The controller 114 may determine the voltage pulse pattern for printing the tri-color tuple at the input temperature at a specific print head element, of the plurality of print head elements 106-1 . . . 106-N, printing the pixel on thermal print medium 108 based on a previously printed pixel with the tri-color tuple printed at the same input temperature. In some examples, the controller 114 may determine the voltage pulse pattern for printing the tri-color tuple at the input temperature at the specific print head element and at the input temperature of the print medium at the area where the pixel is to be printed (e.g., the combined input temperature) based on a previously printed pixel with the tri-color tuple printed at the same combined input temperature.

The controller 114 may determine the voltage pulse pattern by referencing a data structure 112 stored in and/or accessible by the thermal printer 102. The data structure 112 may be formatted to output a voltage pulse pattern based on determined four dimensions of inputs defining the pixel of the image 110 to be printed and the conditions at the thermal print head element and/or the area of the thermal print medium 108 where the pixel will be printed. For example, the data structure 112 may be a four-dimensional (4D) table, The four dimensions of the data structure 112 may include a first dimension including an interpolated range of a first color (e.g., red, cyan, etc.) tuple values of the pixel of the image 110 to be printed, a second dimension including an interpolated range of a second color (e.g., green, magenta, etc.) tuple values of the pixel of the image 110 to be printed, a third dimension including an interpolated range of a third (e.g., blue, yellow, etc.) tuple values of the pixel of the image 110 to be printed, and a fourth dimension including a range of input temperatures for each unique tri-color tuple value. The data structure 112 may include a first color tuple value for every color in the color space reproducible by the thermal printer 102, a second color tuple value for every color in the color space reproducible by the thermal printer 102, and a third color tuple value for every color in the color space reproducible by the thermal printer 102.

The data structure 112 may include an input temperature value for a portion of every input temperature achievable by the thermal print head elements 106-1 . . . 106-N within normal operating parameters for the thermal printer 102. In some examples, the data structure 112 may include an input temperature value for a portion of every input temperature achievable at the thermal print medium 108 within normal operating parameters for the thermal printer 102. In some examples, the data structure 112 may include an input temperature value for a portion of every combined input temperature achievable at the thermal print medium 108 and input temperature achievable at the thermal print medium 108 within normal operating parameters for the thermal printer 102. As such, the data structure 112 may include a specific voltage pulse pattern for a portion of every combination of tri-color tuple values and input temperatures for those tuple values that may be processed by the thermal printer 102.

As described above, the voltage pulse pattern may be the output from the data structure 112. The voltage pulse pattern may be an instruction regarding an amplitude, duration, and/or frequency of a voltage pulse that should be provided to the particular thermal print head element in order to produce a an accurate color match to the tri-color-defined pixel on the thermal print medium 108 at the determined input temperature. An accurate color match may be a color that matches a desired and/or expected target color specified in a source image being printed.

In contrast to color correction functions that utilize a linear cyan color correction model, a linear magenta color correction model, and a linear yellow color correction model to identify changes to voltages applied to heating elements, the voltage pulse pattern output from the data structure 112 is not derived from linear color correction functions. Instead, the voltage pulse pattern of each RGB tuple at each input temperature is empirically derived prior to printing the image 110 on the thermal print medium 108. The voltage pulse patterns may be based on historical data including observed voltage pulse patterns that resulted in printing a pixel with a known tri-color tuple value at a known input temperature.

For example, a manufacturer of a thermal printer 102 may test the thermal printer by printing each potential tri-color tuple value in the color space printable by the thermal printer 102 at each input temperature condition utilizing a plurality of different voltage pulse patterns. The manufacturer may analyze the visible color produced on the print medium 108 for each of these prints. The manufacturer may generate the data structure 112 from such analysis. For example, the manufacturer may identify the accurate color match for each of the potential tri-color tuple values printed starting from each of the input temperature values.

The manufacturer may then populate the data structure 112 by matching the voltage pulse pattern utilized to produce the accurate color match to a tri-color tuple to the corresponding tri-color tuple value and the input temperature value. As such, the data structure 112 may include a voltage pulse pattern output that will produce, on the thermal printing medium 108, a correct color match to a tri-color pixel from an image 110 being printed with the input temperatures at the area where the pixel is to be printed,

By decoupling the color correction from the independent linear cyan color correction function, magenta color correction function, and yellow color correction function that are standardized to a particular color, examples of the present disclosure may decouple the independent correction at cyan, magenta, and yellow from the correction at combinations of cyan, magenta, and yellow. By employing the 4D data structure developed from empirical analysis of the printed results of the thermal printer 102, examples of the present disclosure that empirically models how color shifts in a color space where the effect at the neutral, or at red, for example, is independent from the correction that is used at the neutral axis. The result of implementing the data structure 112 is color correct prints that do not display color shifts and that maintain uniform color appearance across a printed image regardless of changing input temperatures that occur during the printing process.

Further, rather than utilizing an overall average of thermal print head 104 temperatures to analyze thermal correction of colors to be printed, examples of the present disclosure may utilize a temperature of the particular thermal print head element of the plurality of thermal print head elements 106-1 . . . 106-N that is going to print a pixel and/or the temperature of the area of the thermal print medium 108 where the pixel will be printed. Applying overall average thermal print head 104 temperatures ignores differential and/or local heating phenomena of particular thermal print head elements 106-1 . . . 106-N and/or the thermal print medium 108 resulting from previously printed pixels. For example, is the left side of an image 110 being printed on thermal print medium 108 is darker than the right, the left side of the thermal print head 104 and the corresponding portion of the plurality of thermal print head elements 106-1 . . . 106-N may be a higher temperature than those on the right side. Applying the same correction to the left and right side thermal print head elements 106-1 . . . 106-N in such an example will lead to color shift across the printed image. Utilizing the input temperature of the particular thermal print head element of the plurality of thermal print head elements 106-1 . . . 106-N that is going to print a pixel and/or the temperature of the area of the thermal print medium 108 where the pixel will be printed may obviate such color shifts.

As described above, the controller 114 may reference, against the data structure 112, the determined tri-color tuple of a pixel of the image 110 to be printed and the determined input temperature at an area where the pixel is to be printed. As described above, the data structure 112 may include a stored empirically-derived voltage pulse pattern output previously observed for each tri-color tuple value printable by the thermal print head at each of a plurality of input temperatures achievable at the area where the pixel is to be printed. Therefore, the controller 114 may determine, from the data structure 112, the voltage pulse pattern that will print an accurate color match to the color identified by the tri-color tuple with the determined input temperature at the area where the pixel is to be printed.

The controller 114 may deliver the voltage pulse pattern, determined by referencing the data structure 112, to the particular thermal print head element of the plurality of thermal print head elements 106-1 . . . 106-2 that is providing the thermal energy to print the pixel at the area of the thermal print medium 108. The voltage pulse pattern may be converted to thermal energy at the thermal print head element. The thermal energy may be transferred to the thermal print medium 108. The delivered thermal energy may activate the color-forming chemistry of a portion of the three CMY color forming layers producing a color on the thermal print medium 108 that matches the color of the pixel of the image 110 that was printed. In other examples, the delivered thermal energy may activate the color-forming chemistry of a portion of the four CMYK color forming layers producing a color on the thermal print medium 108 that matches the color of the pixel of the image 110 that was printed.

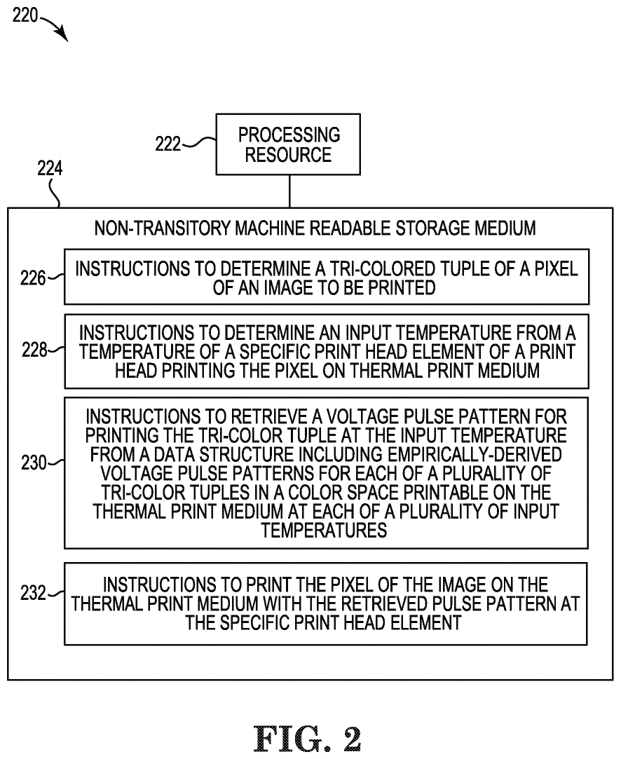

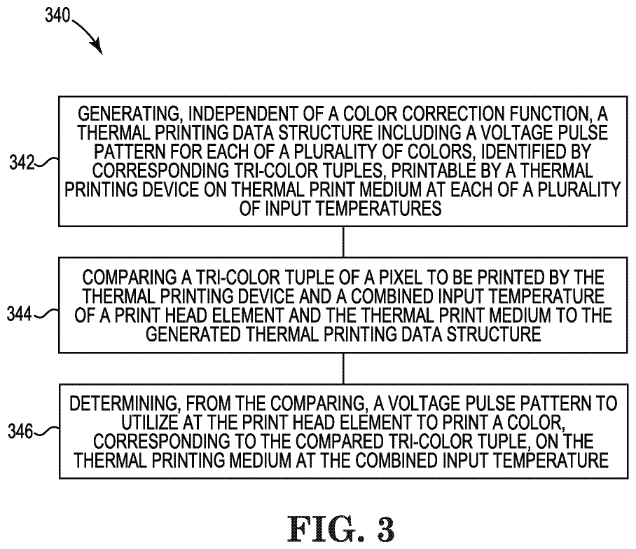

The above-described system 100 is not limited to any single example described herein. The system 100 may be incorporated in and/or additionally include the examples described with respect to the non-transitory machine readable medium 224 of FIG. 2 and/or the method 340 of FIG. 3.

FIG. 2 illustrates a diagram 220 of an example of a processing resource 222 and a non-transitory machine readable medium 224 for thermal print pulse pattern determination consistent with the disclosure. A memory resource, such as the non-transitory machine readable medium 224, may be used to store instructions (e.g., 226, 228, 230, 232) executed by the processing resource 222 to perform the operations as described herein. A processing resource 222 may execute the instructions stored on the non-transitory machine readable medium 224. The non-transitory machine readable medium 224 may be any type of volatile or non-volatile memory or storage, such as random-access memory (RAM), flash memory, read-only memory (ROM), storage volumes, a hard disk, or a combination thereof.

The example medium 224 may store instructions 226 to receive an image to be printed. The image may be a digital representation of an image to be printed on a thermal printer. The image may be received from a computing device that is separate from and/or peripheral to the thermal printer on which the instructions (e.g., 226, 228, 230, 232) are stored and/or executed. The image may include data defining the tri-color (e.g., RGB, CMY, etc.) tuple value of colors appearing at each pixel of the digital representation of the image to be printed. The instructions may include instructions to determine the tri-color tuple of a pixel of the image to be printed. The tri-color tuple may be extracted from a digital file of the image.

The example medium 224 may store instructions 228 to determine an input temperature applicable to the pixel that is to be printed. For example, the input temperature may be determined from a temperature of a specific thermal print head element of a plurality of thermal print head elements present at the thermal print head of the thermal printer. The specific thermal print head element may be the thermal print head element that will be printing a copy of the pixel on to print medium. That is, the specific thermal print head element may be the thermal print head element that will be generating and/or transferring the thermal energy that will activate the color-forming chemistry of the CMY and/or CMYK color forming layers of the thermal print medium to reproduce the tri-color tuple defined pixel onto the print medium. The input temperature may also be determined from the temperature of the thermal print medium. For example, the portion of the thermal print medium where the copy of the pixel will be produced by the thermal print head element may be utilized to determine the input temperature. The input temperature may, therefore, be the temperature of the area where the pixel is to be printed as determined by a combination of the thermal print head element temperature and the thermal print medium temperature. The input temperature may be determined by temperature sensors and/or by temperature modeling utilizing an initial temperature in combination with knowledge of a voltage pulse pattern applied at a thermal print head element. Since the described thermal printing process may be iterative, the input temperature may be tracked and/or periodically updated throughout printing a plurality of pixels making up an image to be printed.

The example medium 224 may store instructions 230 to retrieve, from a data structure, a voltage pulse pattern for printing a accurate color match to the tri-color tuple defined pixel at the determined input temperature. The data structure may include a table. The data structure may include a non-relational database, Regardless of the format of the data structure, the data structure may include empirically-derived voltage pulse patterns for each of a plurality of tri-color tuples of a pixel to be printed in a color space printable on the thermal print medium at each of a plurality of input temperatures. That is, the data structure may take as inputs the first color, second color, and third color tuple values of a pixel of an image to be printed in addition to the input temperature associated with copying that pixel to the thermal print medium. The data structure may output a specific voltage pulse pattern that, when applied to the thermal print head element printing the pixel, has been empirically determined to accurately reproduce the color described in by the tri-color tuple on the thermal print medium. As such, the voltage pulse pattern for printing the tri-color tuple at the input temperature may be determined from the data structure without utilizing a linear correction function. For example, the voltage pulse pattern for thermal print medium that includes CMY color forming layers may be determined from the data structure without utilizing a linear cyan color correction function, a linear magenta color correction function, and/or a linear yellow correction function.

The example medium 224 may store instructions 232 to print the copy of the pixel of the image on the thermal print medium. Printing the copy of the pixel of the image on the thermal print medium may include providing the voltage pulse pattern output from the data structure to the thermal print head element that is producing the thermal energy to produce the copy of the pixel on the print medium. As such, the copy of the pixel may be printed on to the thermal print medium at the particular portion of the thermal print medium from which the input temperature was determine utilizing the retrieved pulse pattern at the specific print head element from which the input temperature was determined.

A thermal print job may include printing a plurality of pixels of an overall image, The plurality of pixels may be printed by the thermal print head in a plurality of successive rasters of pixels. However, the input temperature of the thermal print head and the temperature of the thermal print medium may fluctuate. For example, while printing a first raster of pixels, the surface of the thermal print head element and the surface of the area of the thermal print medium where the second raster of pixels will be printed may change. In an example, residual or excessive thermal energy may bleed to areas of the thermal print medium adjacent to the areas being printed (e.g., a next raster of pixels to be printed). Additionally, residual or excessive thermal energy may be retained in thermal print head elements and/or transferred to adjacent thermal print head elements that may be involved in printing a next raster of pixels to be printed.

As such, the input temperature of an area of a next raster of pixels to be printed may be tracked. For example, the temperature fluctuation of the area for next raster of pixels to be printed that results from the prior printing of the first raster of pixels of the image on the thermal print medium may be tracked. Tracking the temperature of the area of the next raster of pixels following the printing of the first raster of pixels may account for the heat transfer from the printing of the first raster of pixels. The tracked input temperature of the area for the next raster of pixels to be printed may be utilized as the input temperature to retrieve a next voltage pulse pattern for each next pixel of the next raster of pixels to be printed. Utilizing the tracked input temperature of the next raster to be printed rather than an input temperature determined prior to the printing of the first raster of pixels may provide a representation of the present conditions at the next raster and, consequently, will identify a next voltage pattern matched to the present conditions. The tracked input temperature of the next raster along with the tri-color tuple value of a next pixel of the image to be printed in the next raster may be utilized to retrieve, from the data structure, a next voltage pattern to print the next pixel of the image to be printed.

The instructions (e.g., 226, 228, 230, 232) are not limited to any single example described herein. The instructions (e.g., 226, 228, 230, 232) may be incorporated in and/or additionally include the examples described with respect to the system 100 of FIG. 1 and/or the method 340 of FIG. 3.

FIG. 3 illustrates a flow diagram of an example of a method 340 for thermal print pulse pattern determination consistent with the disclosure. At 342, the method 340 may include generating a thermal printing data structure. The thermal printing data structure may be generated independent of a color correction function. For example, the thermal printing data structure may be generated independent of a C, M, or Y color correction function.

The thermal printing data structure may include a voltage pulse pattern for each of a plurality of colors identified by their corresponding tri-color tuples. The thermal printing data structure may include a voltage pulse pattern for each of a plurality of colors printable by a thermal printing device on thermal print medium at each of a plurality of input temperatures. For example, the thermal printing data structure may include a voltage pulse pattern for each of the colors in a color space that are able to be printed by the thermal printer executing the method 340.

The thermal printing data structure may include the voltage pulse patterns generated from empirical data instead of from color correction functions. For example, generating the thermal printing data structure may include printing the each of the plurality of colors at the each of the plurality of input temperatures and recording a corresponding voltage pulse pattern for the each of the plurality of colors at the each of the plurality of input temperatures. In this manner, a data structure may be generated that includes a voltage pulse patterns for each potential printable color at each potential printing temperature of the thermal printing device. As such, utilizing tri-color tuple values of a pixel to be printed and an input temperature as inputs a corresponding voltage pulse pattern may be output from the data structure that has been empirically observed to produce an accurate color match to the pixel on the thermal print medium.

At 344, the method 340 may include comparing, to the generated thermal printing data structure, a tri-color tuple of a pixel to be printed by the thermal printing device, a combined input temperature of a print head element that will print the pixel, and/or the thermal print medium. The data structure may include a 4-D data structure that contains a voltage pulse pattern for each potential tri-color tuple of a pixel at each potential input temperature.

At 346, the method 340 may include determining, from the comparison, a voltage pulse pattern to utilize at the print head element to print a color on the thermal printing medium at the compared input temperature. The color may be a color corresponding to color described by the compared tri-color tuple. Additionally, the combined input temperature of the print head element and the thermal print medium may be adjusted. For example, the combined input temperature may be adjusted to account for a thermal bleed. A thermal bleed may include the unintended bleed of heat energy from an adjacent hot pixel. The combined input temperature may be adjusted prior to comparing the combined input temperature to the thermal printing structure to identify a voltage pulse pattern to print the color corresponding to a tri-color tuple of a pixel to be printed.

The method 340 is not limited to any single example described herein. The method 340 may be incorporated in and/or additionally include the system 100 of FIG. 1 and/or the instructions (e.g., 226, 228, 230, 232) described with respect to FIG. 2.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. A “plurality of” is intended to refer to more than one of such things.

The figures herein follow a numbering convention in which the first digit corresponds to the drawing figure number and the remaining digits identify an element or component in the drawing. For example, reference numeral 102 may refer to element “02” in FIG. 1. Elements shown in the various figures herein can be added, exchanged, and/or eliminated so as to provide a number of additional examples of the disclosure. In addition, the proportion and the relative scale of the elements provided in the figures are intended to illustrate the examples of the disclosure, and should not be taken in a limiting sense. Further, as used herein, “a”, “a number of”, and/or “a plurality of” an element and/or feature can refer to one or more of such elements and/or features.

What is claimed:

1. A system for thermal printing, comprising:
a thermal print head including a plurality of print head elements to heat a print medium; and
a controller to:
determine a tri-color tuple of a pixel of an image to be printed;
determine an input temperature at a particular print head element of the plurality of print head elements, the particular print head element to print the pixel on thermal print medium; and
determine a voltage pulse pattern for printing the tri-color tuple at the input temperature based on a previously printed pixel.

2. The system of claim 1, wherein the input temperature is to be determined based on sensing a temperature of the particular print head element providing thermal energy to print the pixel.

3. The system of claim 2, wherein the controller is further to determine the input temperature of the print medium at an area where the pixel is to be printed.

4. The system of claim 3, wherein the controller is further to determine the voltage pulse pattern for printing the tri-color tuple based on the input temperature of the print medium at the area where the pixel is to be printed.

5. The system of claim 1, wherein determining the voltage pulse pattern includes referencing a data structure including a first dimension including an interpolated range of red tuple values of the pixel of the image to be printed, a second dimension including an interpolated range of green tuple values of the pixel to be printed, a third dimension including an interpolated range of blue tuple values of the pixel to be printed, and a fourth dimension including an interpolated range of input temperatures for each unique red, green, blue tuple.

6. The system of claim 1, wherein the voltage pulse pattern for each tri-colored tuple printable by the thermal print head at each input temperature achievable by the particular print head element is to be empirically determined prior to printing on the print medium.

7. The system of claim 1, wherein the print medium is to include a cyan color forming layer, a magenta color forming layer, and a yellow color forming layer.

8. The system of claim 1, wherein the voltage pulse pattern for each tri-color tuple in the table is derived other than from a correction function.

9. A non-transitory machine-readable medium storing instructions that, when executed by a processing resource of a thermal printer, cause the processing resource to:
determine a tri-colored tuple of a pixel of an image to be printed;
determine an input temperature from a temperature of a specific print head element of a print head to print the pixel on thermal print medium;
retrieve a voltage pulse pattern for printing the tri-color tuple at the input temperature from a data structure including empirically-derived voltage pulse patterns for each of a plurality of tri-color tuples in a color space printable on the thermal print medium at each of a plurality of input temperatures; and
print the pixel of the image on the thermal print medium with the retrieved pulse pattern at the specific print head element.

10. The medium of claim 9, further including instructions to track an input temperature of an area of a next raster to be printed resulting from the print of the pixel of the image on the thermal print medium.

11. The medium of claim 10, further comprising instructions to utilize the tracked input temperature along with a tri-colored tuple of a next pixel of the image to be printed in the next raster to retrieve a next voltage pulse pattern from the data structure.

12. The medium of claim 9, further comprising instructions to retrieve the voltage pulse pattern for printing the tri-colored tuple at the input temperature from the data structure without utilizing a linear cyan color correction function, a linear magenta color correction function, and a linear yellow correction function.

13. A method, comprising:
generating, independent of a color correction function, a thermal printing data structure including a voltage pulse pattern for each of a plurality of colors, identified by corresponding tri-color tuples, printable by a thermal printing device on thermal print medium at each of a plurality of input temperatures;
comparing a tri-color tuple of a pixel to be printed by the thermal printing device and a combined input temperature of a print head element and the thermal print medium to the generated thermal printing data structure; and
determining, from the comparing, a voltage pulse pattern to utilize at the print head element to print a color, corresponding to the compared tri-color tuple, on the thermal printing medium at the combined input temperature.

14. The method of claim 13, wherein generating the thermal printing data structure includes printing the each of the plurality of colors at the each of the plurality of input temperatures and recording a corresponding voltage pulse pattern for the each of the plurality of colors at the each of the plurality of input temperatures.

15. The method of claim 13, comprising adjusting the combined input temperature of the print head element and the thermal print medium to account for a thermal bleed from an adjacent hot pixel prior to comparing to the thermal printing data structure.
